(19) United States
(12) Patent Application Publication
(10) Pub. No.: US 2011/0094481 A1
(43) Pub. Date: Apr. 28, 2011

(54) EXHAUST GAS RECIRCULATION VALVE DEVICE

(76) Inventors: Takuro Zui, Tokyo (JP); Naosuke Nojima, Tokyo (JP); Haruo Watanuki, Tokyo (JP); Sotsuo Miyoshi, Tokyo (JP)

(21) Appl. No.: 12/992,669

(22) PCT Filed: Jun. 24, 2009
(86) PCT No.: PCT/JP2009/002896

§ 371 Date: Nov. 15, 2010

(30) Foreign Application Priority Data
Aug. 13, 2008 (JP) 2008-208485

(51) Int. Cl. F02M 25/07

(52) U.S. Cl. 123/568.11

(57) ABSTRACT

In an exhaust gas recirculation valve device, a sealing member 15 supported by a plug 15c is disposed between a portion of a housing 1 on an exhaust gas passage side of a bearing 8, and a valve shaft 7.

### FIELD OF THE INVENTION

The present invention relates to an exhaust gas recirculation valve device that prevents an exhaust gas, a foreign object, water, and so on from leaking from a clearance gap between a valve shaft and a bearing to a sliding portion of the valve shaft and an actuator section for driving the valve shaft by disposing, for example, a sealing member in an exhaust gas passage.

### BACKGROUND OF THE INVENTION

A conventional exhaust gas recirculation valve device has an exhaust gas passage which is formed in a housing thereof, and a valve disposed therein for opening and closing this exhaust gas passage. This valve is supported by a valve shaft and this valve shaft is supported by a bearing disposed in the housing. An actuator is attached to the housing, and an actuator shaft positioned along an extension of the axis of the valve shaft and a driving member for moving this actuator shaft forwardly and backwardly in directions of the axis of the valve shaft are built in the actuator.

The conventional exhaust gas recirculation valve device adjusts the opening of the exhaust gas passage by operating the driving member to move the actuator shaft in a direction of the axis of the valve shaft to push the valve shaft and hence move the position of the valve. The conventional exhaust gas recirculation valve device thus adjusts the amount of the exhaust gas. In this conventional exhaust gas recirculation valve device, in order to prevent the exhaust gas, a foreign object, water, and so on from intruding from the clearance gap between the valve shaft and the bearing into the sliding portion of the valve shaft, and the actuator section for driving the valve shaft, thereby preventing a reduction in the sliding property of the valve shaft, and degradation in the moving performance of the actuator shaft, a sealing member movable and deformable within a predetermined area is disposed in a sliding supporter of the valve shaft, as disclosed in, for example, patent reference 1,

### Related Art Document

### Patent Reference

### [Patent Reference 1] JP, 2005-120932,A

### SUMMARY OF THE INVENTION

Because the conventional exhaust gas recirculation valve device is constructed as above, a problem with the conventional exhaust gas recirculation valve device is that the sealing member cannot exhibit its seal performance unless an exhaust gas pressure occurring from the exhaust gas passage acts on the sealing member.

It is therefore an object of the present invention to provide an exhaust gas recirculation valve device that facilitates attachment of a sealing member to a housing thereof, and that, by applying the sealing member thereto, can surely prevent an exhaust gas, a foreign object, water, and so on form leaking from a clearance gap between a valve shaft and a bearing to a sliding portion of the valve shaft and an actuator section for driving the valve shaft without being influenced by an exhaust gas pressure.

In accordance with the present invention, there is provided an exhaust gas recirculation valve device in which a sealing member supported by a plug is disposed between a portion of a housing on an exhaust gas passage side of a bearing, and a valve shaft.

In accordance with the present invention, because the sealing member supported by the plug is disposed between the portion of the housing on the exhaust gas passage side of the bearing, and the valve shaft, the seal performance of the sealing member sealing surface between the valve shaft and the bearing can be improved dramatically. Furthermore, attachment of this sealing member to the housing can be improved, and the sealing member can be attached to a position where the diameter of the attachment differs by changing only the outer diameter of the plug,

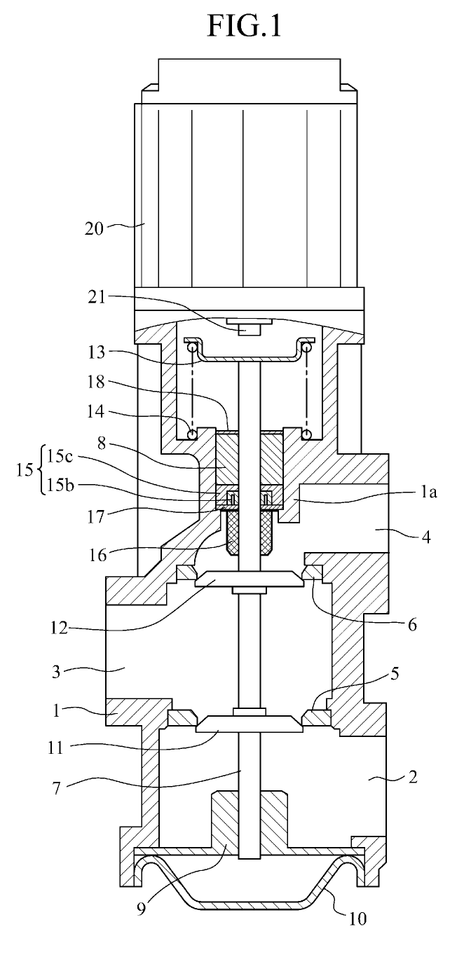

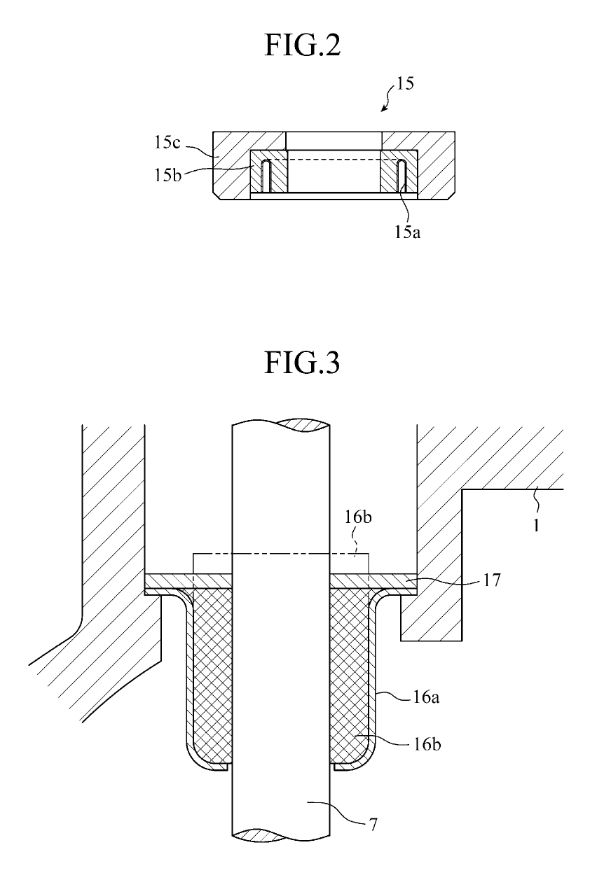

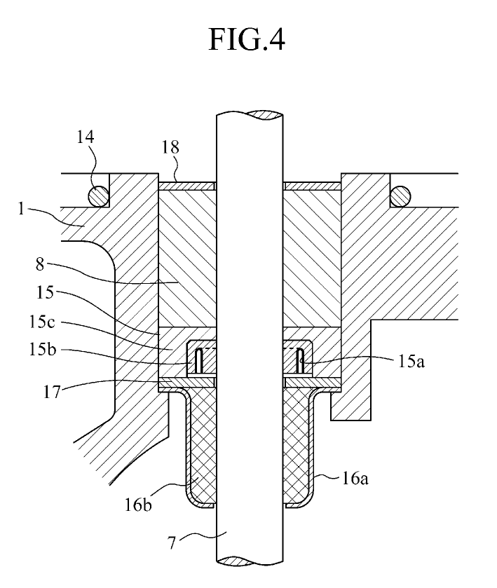

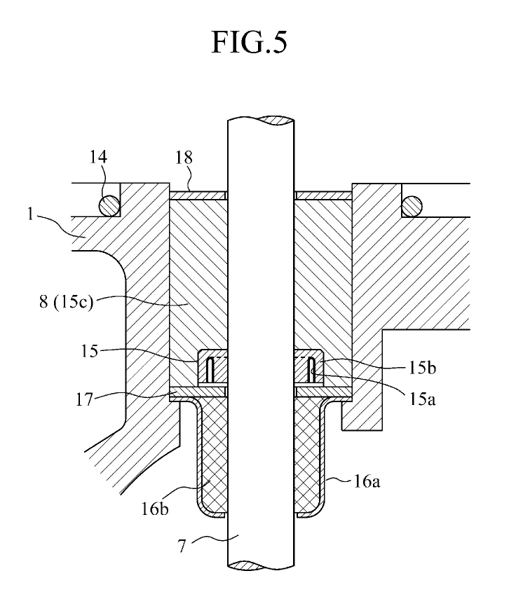

### BRIEF DESCRIPTION OF THE FIGURES

[FIG. 1] FIG. 1 is a longitudinal sectional front view, partly in section, showing an exhaust gas recirculation valve device in accordance with Embodiment 1 of the present invention;

[FIG. 2] FIG. 2 is a longitudinal sectional view of a sealing member;

[FIG. 3] FIG. 3 is an enlarged vertical longitudinal sectional front view of a filter section;

[FIG. 4] FIG. 4 is an enlarged vertical longitudinal sectional front of a bearing and its surroundings; and

[FIG. 5] FIG. 5 is an enlarged vertical longitudinal sectional front view of a bearing and its surroundings in accordance with Embodiment 2.

### EMBODIMENTS OF THE INVENTION

Hereafter, in order to explain this invention in greater detail, the preferred embodiments of the present invention will be described with reference to the accompanying drawings.

### Embodiment 1

FIG. 1 is a longitudinal sectional front view, partly in section, showing an exhaust gas recirculation valve device in accordance with Embodiment 1 of the present invention, and FIG. 2 is a longitudinal sectional view of a sealing member. In FIGS. 1 and 2, a housing 1 is provided with a single exhaust gas inlet 3 and two exhaust gas outlets 2 and 4, and also has valve seals 5 and 6 which connect the exhaust gas inlet 3 and the two exhaust emission outlets 2 and 4 respectively.

A valve shaft 7 is supported in an internal central part of the housing 1 via a bearing 8 in such a way as be able to move in directions of the axis thereof. Furthermore, while a lower end of the valve shaft 7 is supported by a steady rest member 9 disposed at an end of the housing 1 in such a way as to be movable, and a lid 10 is disposed on an end surface of the housing 1 in such a way as to cover an outer surface of this steady rest member 9. This lid 10 bulges outwardly so as to ensure a range of movements of the valve shaft 7.

In the middle of the valve shaft 7, two valve shaft portions 11 and 12 are attached with them being associated with the valve seals 5 and 6 respectively. Furthermore, a spring retaining seat 13 is attached to an upper end of the valve shaft 7, and a pushing member 14, such as a coil spring, which is compressed between this spring retaining seat 13 and the housing 1, is disposed. With this configuration, the valve shaft 7 is pushed toward a direction in which the valve shaft portions 11 and 12 always come into contact with the valve seals 5 and 6 respectively according to the pushing force of the pushing member 14.

While the sealing member 15 is disposed between a portion of the housing 1 on an exhaust gas passage side of the bearing 8, and the valve shaft 7, and a filter 16 is disposed on an exhaust gas passage side of this sealing member 15. As shown in FIG. 2, in the sealing member 15, a spring member 15a, e.g., a metallic spring member having a cross section which is bent like the letter U is formed into a ring shape, the outer surfaces of this metallic spring member 15a, excluding an aperture side surface of this metallic spring member 15a having a cross section shaped like the letter U, are covered by an elastic resin 15b, and a plug 15c is disposed on an outer surface of this elastic resin 15b.

As shown in FIGS. 3 and 4, in the filter 16, a cylindrical wire net 16b having a hole through which the valve shaft 7 is passed is accommodated and supported in a cup-shaped holder 16a having an outwardly-protruding flange at an upper end of the filter and a penetrating hole through which the valve shaft 7 is passed at a center of a lower end bottom of the filter. In this embodiment, the wire net 16b has a length longer than the depth of the cup-shaped holder 16a before accommodated in the cup-shaped holder 16a, and is pressed into the cup-shaped holder 16a by using a plate 17 when accommodated in the cup-shaped holder 16a. As a result, the wire net 16b becomes deformed so as to reduce the diameter of the hole thereof, and comes into contact with the surface of the valve shaft 7 accurately.

An actuator 20 is attached onto the housing 1. In this actuator 20, an actuator shaft 21 positioned on an extension line of the axis of the valve shaft 7, and a driving member (not shown) for moving this actuator shaft 21 forwardly and backwardly along directions of the axis of the valve shaft are built.

Next, an attachment process will be explained.

First, after the cup-shaped holder 16a, the wire net 16b, and the plate 17 are inserted into a bearing supporting portion la within the housing 1 from an atmospheric air side of the housing, the sealing member 15 is press-fitted into the bearing supporting portion, the bearing 8 is further inserted into the bearing supporting portion, a fixing plate 18 is finally inserted into the bearing supporting portion 1a toward a top surface of the bearing 8 so as to fix the whole of these components. Then, after the two valve shaft portionsll and 12 are attached and fixed to the valve shaft 7 with them being placed at the same interval as that at which the valve seals 5 and 6 are arranged, this valve shaft 7 is inserted into the housing 1 from the lower side of the housing, and the top end portion of this valve shaft 7 is passed through the central holes of the filter 16, the plate 17, the sealing member 15, the bearing 8, and the fixing plate 18. Then, the spring retaining seat 13 is attached and fixed to the upper end of the valve shaft 7 passed through the central holes with the pushing member 14 being compressed. After that, the steady rest member 9 is fitted into the bottom end of the valve shaft 7, and the lid 10 is attached to the end surface of the housing 1 in such a way as to cover the outer surface of this steady rest member 9.

Next, control of the discharge of the exhaust gas will be explained. First, when the driving member disposed in the actuator 20 is made to operate to move the actuator shaft 21 forwardly, the leading end of this actuator shaft 21 comes into contact with the upper end of the valve shaft 7, and, after that, the valve shaft 7 is pushed and moved against the pushing force of the pushing member 14 according to the forward movement of the actuator shaft 21, and the valve shaft portions 11 and 12 move away from the valve seals 5 and 6 respectively. As a result, the exhaust gas inlet 3 and the exhaust gas outlet 2 communicate with each other while the exhaust gas inlet 3 and the exhaust gas outlet 4 communicate with each other.

The exhaust gas flowing into the valve from the exhaust gas inlet 3 flows into the exhaust gas outlets 2 and 4. At this time, the pressure of the exhaust gas acts on the sealing member 15. This pressure acts on the metallic spring member 15a of the sealing member 15 so as to outwardly extend both the U-shaped left-side and right-side portions of the metallic spring member in leftward and rightward directions, respectively. Consequently, the elastic resin 15b covering the outer surface of the metallic spring member 15a is pressed against the valve shaft 7.

As a result, the exhaust gas recirculation valve device can certainly prevent a reduction in the sliding property of the valve shaft 7 and degradation in the moving performance of the actuator 20 resulting from intrusion of the exhaust gas, a foreign object, water, and so on from the clearance gap between the valve shaft 7 and the bearing 8 into the sliding portion of the valve shaft 7, and the actuator 20 for driving the valve shaft portions 11 and 12.

Furthermore, because the filter 16, the sealing member 15, and the bearing 8 are arranged in the housing in the order from the exhaust gas passage side of the housing, soot (deposits) in the exhaust gas adhered to the surface of the valve shaft 7 can be scraped from the surface by using the filter 16 at the time of movements of the valve shaft 7 in directions of the axis of the valve shaft, i.e., at the time of opening and closing the valve shaft portions 11 and 12. As a result, the valve shaft 7 whose outer diameter has become large due to adhesion of deposits thereto can be prevented from entering the sealing member 15 to open the valve and be firmly fixed to the sealing member.

Furthermore, because the cylindrical wire net 16b having a diameter larger than the cup-shaped holder 16a is press-deformed by the plate 17 and is accommodated and supported in the cup-shaped holder 16a in the filter 16, the filter 16 is brought into contact with the surface of the valve shaft 7 accurately, thereby being able to certainly scrape and remove deposits adhered to the surface of the valve shaft 7. Therefore, the above-mentioned advantage can be provided more certainly.

### Embodiment 2

FIG. 5 is an enlarged vertical longitudinal sectional view showing a bearing and its surroundings in accordance with Embodiment 2 of the present invention. In this Embodiment 2, a sealing member 15 is formed integrally with a bearing 8. In this case, the bearing 8 has the function of a plug 15c. Because the sealing member 15 is thus formed integrally with the bearing 8, the component count is reduced and assembly of the components in a housing 1 is further improved.

In the embodiments illustrated in the figures, the case in which the sealing member 15 supported by the plug 15c is applied to the exhaust gas recirculation valve device disposed in the exhaust gas passage extending from an engine, for controlling the flow of the exhaust gas is explained. This sealing member 15 can be similarly applied to a valve device having another structure for controlling the flow of a gas.

### INDUSTRIAL APPLICABILITY

As mentioned above, because the exhaust gas recirculation valve device in accordance with the present invention is constructed in such a way as to include a sealing member disposed between a portion of a housing on an exhaust gas passage side of a bearing and a valve shaft, and supported by a plug, in order to improve attachment of the sealing member to the housing, and to surely prevent an exhaust gas, a foreign object, water, and so on from leaking from the clearance gap between the valve shaft and the bearing to a sliding portion of the valve shaft and an actuator section for driving the valve shaft without being influenced by an exhaust gas pressure by applying the sealing member to the exhaust gas recirculation valve device, the exhaust gas recirculation valve device is suitable for use as an exhaust gas recirculation valve device or the like that prevents the exhaust gas and so on from leaking to the above-mentioned portions.

1-5. (canceled)

6. A exhaust gas recirculation valve device equipped with a housing in which an exhaust gas passage is formed, a valve shaft supported via a bearing in said housing in such a way as to be movable in directions of an axis thereof, a valve element attached to said valve shaft in such a way as to open and close said exhaust gas passage, a pushing member for pushing said valve shaft in a valve closing direction, and an actuator attached to said housing and having an actuator shaft for driving said valve shaft in a valve opening direction, wherein
a sealing member having a spring member and an elastic resin portion disposed in such a way as to cover an outer surface of said spring member is disposed between said housing and said valve shaft, and said sealing member presses said elastic resin portion against said valve shaft by virtue of an outward extension of said spring member in a radial direction and also presses a plug disposed on an outer surface of said sealing member against said housing.

7. The exhaust gas recirculation valve device according to claim 6, wherein a filter for removing deposits on a surface of the valve shaft is disposed on an exhaust gas passage side of the sealing member.

8. The exhaust gas recirculation valve device according to claim 7, wherein the filter, the sealing member, and the bearing are arranged in the housing in order of either the filter, the sealing member and the bearing or the filter, the bearing and the sealing member when seen from the exhaust gas passage side of the housing.

9. The exhaust gas recirculation valve device according to claim 7, wherein a plate for compressing the filter in a direction of the axis of the valve shaft is disposed between said filter and the sealing member.

10. The exhaust gas recirculation valve device according to claim 6, wherein the bearing and the plug are formed integrally with each other.
